(19) United States
(12) Patent Application Publication
(10) Pub. No.: US 2018/0082498 A1
(43) Pub. Date: Mar. 22, 2018

(54) VAR Diagnostics

(71) Applicant: Vittay Richard, Baton Rouge, LA (US)

(72) Inventor: Vittay Richard, Baton Rouge, LA (US)

(21) Appl. No.: 15/654,654

(22) Filed: Jul. 19, 2017

Related U.S. Application Data
(60) Provisional application No. 62/397,808, filed on Sep. 21, 2016.

(51) Int. Cl. G07C 5/08; G01C 21/36

(52) U.S. Cl. CPC G07C 5/0808; G07C 2205/02; G07C 5/0841; G01C 21/3679

(57) ABSTRACT

It is also capable of reading computer codes and transmitting the codes to identify the exact parts needed and found as an error with the vehicle. When the make, model, and engine size is entered on the app, the system will locate the exact position of the part in or on the engine and zoom in on it so it is easily found. You will have the ability to order the part for your vehicle through the app on your mobile device and pick up at your local retailer store.

### FIELD OF THE INVENTION

The present invention relates generally to a simple user friendly application that diagnoses problems that are specific to car engines.

### BACKGROUND OF THE INVENTION

Diagnosing car problems, such as related to the engine, is often difficult. The present invention seeks to assist with such diagnostics, focusing on problems specific to car engines (e.g. starter, engine block, or spark plug issues). The app will function from the computer of the vehicle through a plug-in wire to the user's phone. The app will upload the make and model of the vehicle and then diagnose the problem. Once the app diagnoses the problem, it will then give a graphical blueprint of the motor where the problem is located when available. The app will provide a step by step 3-D animation breakdown of where the part is.

### BRIEF DESCRIPTION OF THE DRAWINGS

FIG. 1 is a view of the present invention.

FIG. 2 is a view of the present invention.

FIG. 3 is a view of the present invention.

FIG. 4 is a view of the present invention.

### DETAIL DESCRIPTIONS OF THE INVENTION

All illustrations of the drawings are for the purpose of describing selected versions of the present invention and are not intended to limit the scope of the present invention.

The present invention is a software application run via a smart device, such as a mobile phone, that is connected to a car. The steps of the present invention generally detail connecting the smart device to a car, running a diagnostic test to identify an issue, outputting the results of the diagnostic test to the smart device, and outputting additional information to help a user solve the diagnosed issue.

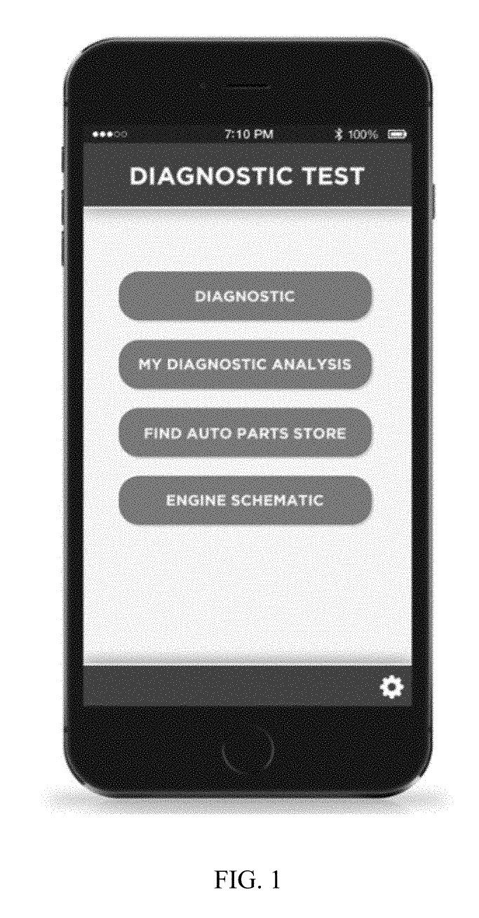

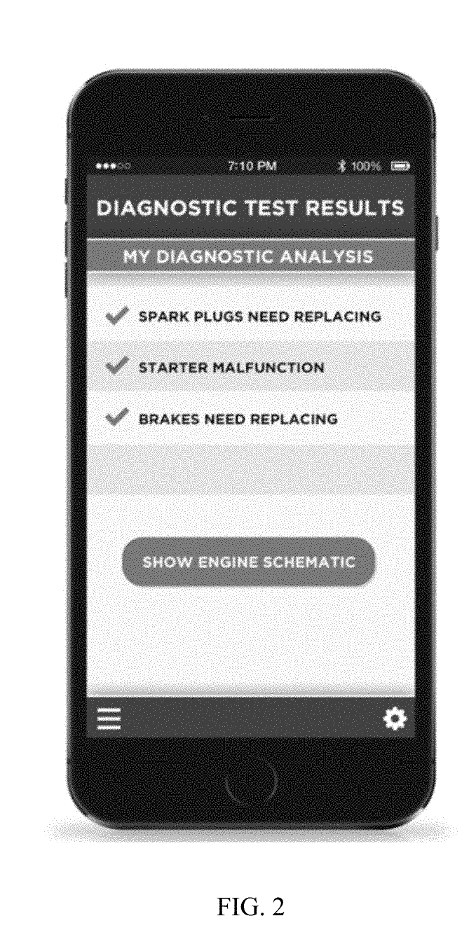

The smart device functions from a computer of the vehicle. An example of such a computer is the engine control unit (ECU). Once an electronic connection with the computer is established, the smart device is able to run a diagnostics test to determine what is wrong with the engine. An on-board diagnostic system (OBD) is another example of an onboard computer that can be utilized by the present invention. Once connected, a user has the option to run a diagnostic test, as shown in FIG. 1. The results of the diagnostic test are output to the smart device, as shown in FIG. 2.

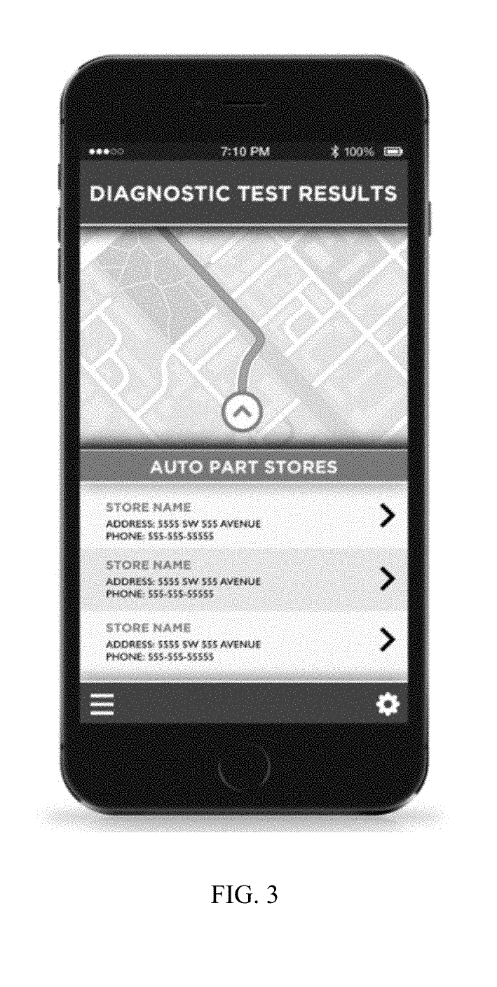

In addition to displaying diagnostic results, the software application can use geographic location data from the user's smart device to help find replacement parts. The software application can find retail outlets within a geographical radius that have a needed part in stock, making it easier for a user to obtain need parts. Such a map is shown in FIG. 3.

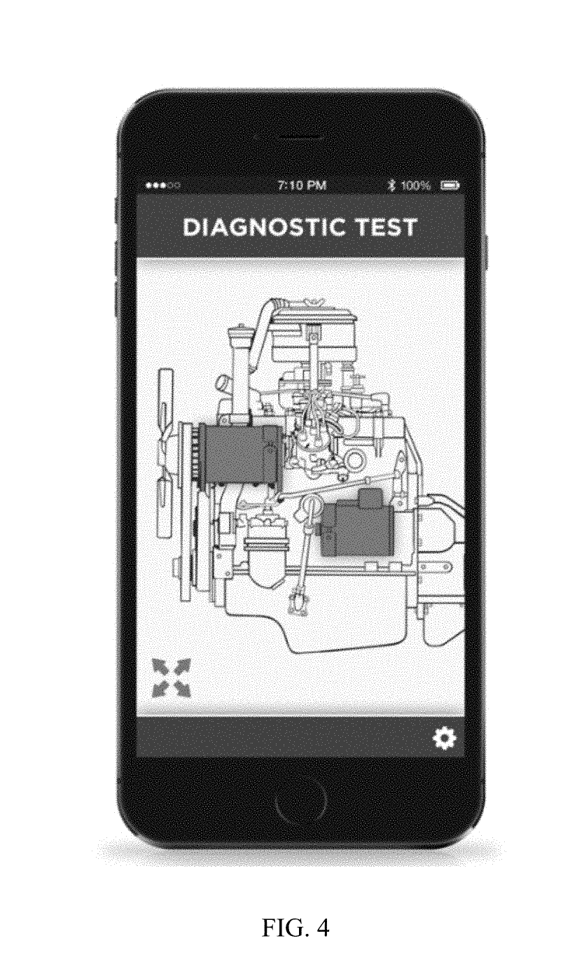

After running a diagnostic and determining the issue, the present invention displays to the smart device a graphic blueprint of the engine. This blueprint helps a user locate the region of the issue. Once the problem has been located, the user (if capable) can the proceed to initiate repairs. Instructions for repairs may be provide directly through the software application. If the user is not capable of comfortable with performing repairs, they can provide the relevant information to a mechanic, saving time and money that would otherwise go to paying the mechanic to diagnose the issue. An example of said blueprint is provided through FIG. 4.

The software application can also create and maintain records for different vehicles, allowing persons to check the repair history of a given vehicle through the software application.

Although the invention has been explained in relation to its preferred embodiment, it is to be understood that many other possible modifications and variations can be made without departing from the spirit and scope of the invention.

1. A software app diagnostic apparatus comprising:
A) 3D engine animation view;
B) Precise engine part error function to said animation view of software app;
C) Diagnostic history to said software app

2. A vehicle diagnostic testing device apparatus comprising:
D) Precise engine part error function;
E) User friendly connectivity to said diagnostic software app;
F) Precise part locator to said vehicle diagnostic testing device

3. Software diagnostic app and diagnostic testing device comprising:
G) Software app and device operation function coincide for proper testing
H) Process of software app
I) Process of diagnostic testing device

4. VAR Diagnostics comprising:
J) VAR Diagnostics name
K) VAR Diagnostics logo
L) VAR elements
